(19) United States
(12) Patent Application Publication
(10) Pub. No.: US 2013/0123974 A1
(43) Pub. Date: May 16, 2013

(54) COMBINED PHARMACEUTICAL PACKAGER AND PREPACKAGED PHARMACEUTICAL SYSTEM

(71) Applicant: Talyst Inc., Kirkland, WA (US)

(72) Inventor: Darcy O. Clarke, Kent, WA (US)

(73) Assignee: Talyst Inc., Kirkland, WA (US)

(21) Appl. No.: 13/674,676

(22) Filed: Nov. 12, 2012

Related U.S. Application Data
(60) Provisional application No. 61/558,968, filed on Nov. 11, 2011.

(51) Int. Cl. G06F 17/00

(52) U.S. Cl. CPC G06F 17/602
USPC 700/236; 700/232

(57) ABSTRACT

A medication dispenser and organization assembly includes a cabinet housing having at least first and second openings and first and second storage units for selectively storing at least one of a prepackaged oral solid medication and a non-oral solid medication. The first and second storage units are removably received within either one of the first and second openings in the cabinet housing and are selectively locked within the cabinet housing by first and second locking mechanisms. The assembly further includes a computing device configured to receive input selecting at least one medication to be dispensed and configured to output a first signal in response to the input. A controller is operably coupled to the first and second storage units and is configured to receive the first signal from the computing device and output a second signal to unlock at least one of the first and second storage units.

### CROSS-REFERENCE TO RELATED APPLICATION

This application claims the benefit of Provisional Application No. 61/558,968, filed Nov. 11, 2011, the disclosure of which is hereby expressly incorporated by reference.

### BACKGROUND

Secure, accurate tracking and dispensing of medications is crucial to the modern practice of medicine, particularly in hospital settings, pharmacies, and long term care facilities, such as nursing homes. To provide readily accessible medication at a particular site a large formulary of available medications are often stored within a dispensing machine located at the site that is capable of dispensing medications when needed. To prevent incorrect or unauthorized medications from being dispensed, use of the dispensing machine is often limited to authorized personnel only. Moreover, to control inventory and prompt reorders, it is helpful to track the dispensed medications.

Oral solid medication packagers are well-known as equipment that can produce bar-coded packets of oral solid medications (“pills”). With the bar codes, it is possible to track medication so that the pharmacy, hospital, or facility knows which patient was given what medication and at what time. This leads to reducing the medication error rate in hospital settings. In a packager, each medication is placed in a canister having a singulating device that is calibrated specifically for that medication. Typically, upon command from the software, a pill will drop from the canister and travel down a chute which leads to the packaging mechanism. The pill is then inserted in the package which is then sealed. Prior to receiving the pill, information, including the bar code, is printed on the package.

It is also often necessary to distribute medications other than pills, such as creams, lotions, powders, liquids, etc. Such medications cannot be dispensed and labeled in a packager as described above. In other situations, pharmacy or facility personnel may need to have an Emergency Kit or an “E-Kit” on-hand and available for use. An E-Kit may be stocked with a 7-10 day supply of the most common medications each facility uses. The contents of each E-kit may be determined by the pharmacy or facility based on data from the facility's medication usage. The E-Kit could contain both pills dispensable by the packager and medications that could not be dispensed and packaged in a packager.

In an urgent situation, a nurse can take a medication from an E-Kit if a new medication was prescribed and the patient needed to start taking it right away. After taking from the E-Kit, the nurse will typically fax the medication orders to the pharmacy. The pharmacy could then dispense the new medication and it would be delivered on the next scheduled delivery to replenish the E-Kit. This process is time consuming and inefficient. Moreover, there is no reliable method to track the medications used in the E-Kits.

Thus, there is a need for an improved method for efficiently and reliably tracking and dispensing medications in E-Kits or similar types of prepared medications or medication kits.

### SUMMARY

A medication dispenser and organization assembly includes a cabinet housing having at least first and second openings and first and second storage units for selectively storing at least one of a prepackaged oral solid medication and a non-oral solid. The first and second storage units are removably received within either one of the first and second openings in the cabinet housing and are selectively locked within the cabinet housing by first and second locking mechanisms. The assembly further includes a computing device configured to receive input selecting at least one medication to be dispensed and configured to output a first signal in response to the input. A controller is operably coupled to the first and second storage units and is configured to receive the first signal from the computing device and output a second signal to unlock at least one of the first and second storage units.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated by reference to the following detailed description, when taken in conjunction with the accompanying drawings, wherein:

FIG. 1 is a graphical depiction of a pharmaceutical packager and product organization system formed in accordance with an exemplary embodiment of the present disclosure;

FIG. 2 is an isometric environmental view of a portion of the pharmaceutical packager and product organization system of FIG. 1, which depicts a medication packager and dispenser, a medication tracking and organization assembly, and a computing device;

FIG. 3 is a front isometric view of the medication tracking and organization assembly of FIG. 2;

FIG. 4 is a rear isometric view of the medication tracking and organization assembly of FIG. 2;

FIG. 5A is a front isometric view of a drawer unit of the medication tracking and organization assembly of FIG. 2; and

FIG. 5B is a rear isometric view of the drawer unit of FIG. 4A.

### DETAILED DESCRIPTION

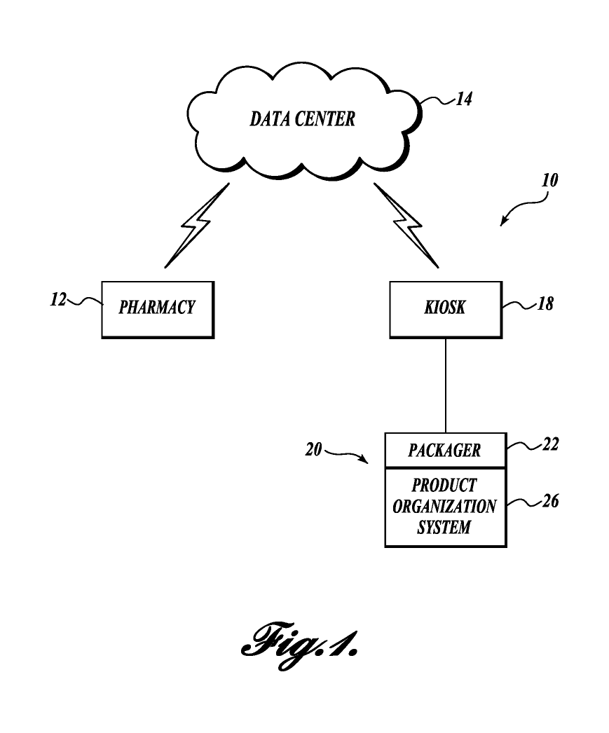

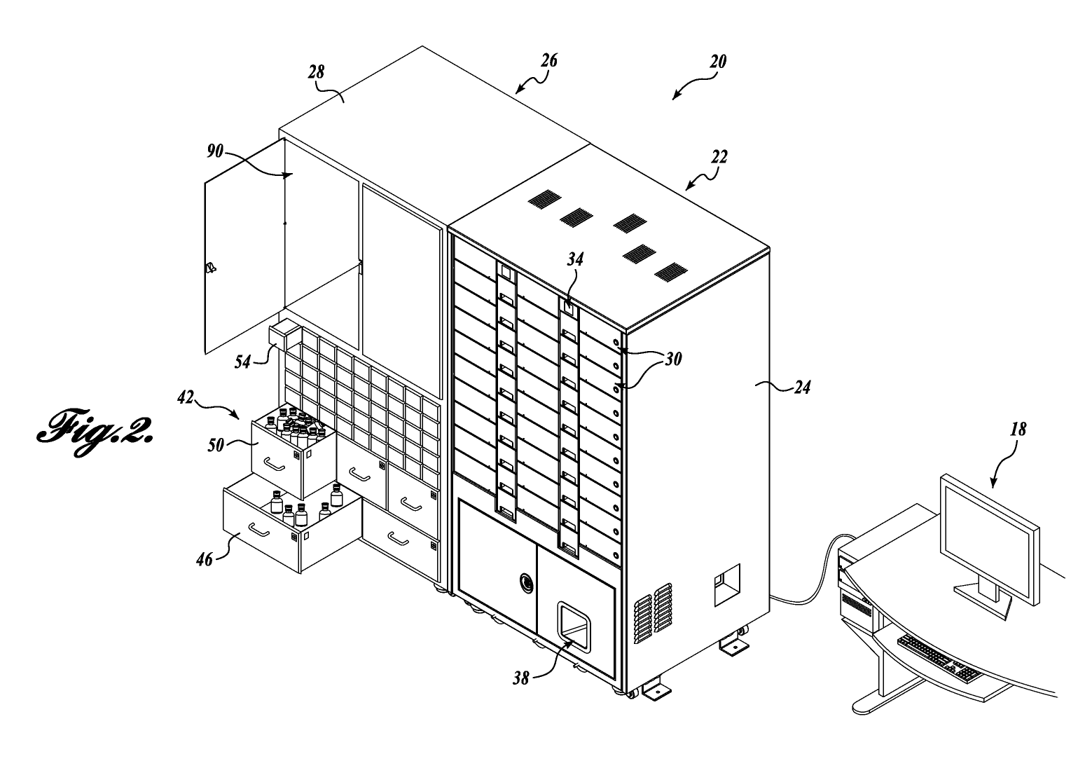

An exemplary embodiment of a pharmaceutical packager and product organization system 10, formed in accordance with an exemplary embodiment of the present disclosure may best be seen by referring to FIGS. 1 and 2. The pharmaceutical packager and product organization system 10 includes a pharmacy 12 or other entity that is capable of receiving and processing prescriptions in any suitable manner. The processed prescriptions are sent to a computing device or kiosk 18 in communication with a medication dispenser 20. In response to commands sent from the pharmacy, the kiosk 18 instructs the medication dispenser 20 to dispense and track medications.

Both of the pharmacy 12 and the kiosk 18 are in networked communication with a data center 14. Any suitable interface between the data center 14 and the pharmacy 12 and between the data center 14 and the kiosk 18 may be used, such as TCP/IP. The data center 14 is the centralized controlling network of the pharmaceutical packager and product organization system 10. The data center 14 receives instructions from the pharmacy 12 and communicates with the kiosk 18 for instructing the medication dispenser 20 to dispense medications and monitor the dispensing activities. It should be appreciated that the pharmacy 12 and the data center 14 may also be in communication with numerous other kiosks 18 and medication dispensers 20 located at the same or different locations. Moreover, the data center 14 may also be in communication with electronic devices (such as personal digital assistants (PDA's), cell phones, etc.) of nurses, doctors, or other personnel for receiving notifications, alerts, etc., regarding the dispensing and tracking of medications. However, the system 10 will be hereinafter described as having only a pharmacy 12, a data center 14, and a single kiosk 18 and medication dispenser 20 for ease of description and illustration.

The pharmacy 12 includes a pharmacy information system (“Phis”) having software that is capable of receiving and processing prescriptions for each patient. Although any suitable information system and software may be used, an exemplary Phis and associated software will be hereinafter described.

The prescriptions are sent to the pharmacy 12 from the data center 14 (or any other data source) or from a request originated through a doctor or patient. The prescription is entered into the Phis, and each prescription is saved to a Phis order file that also includes other prescriptions for the patient or E-Kit. The Phis processes each prescription by creating a dispense order batch file that divides the prescription into single line orders. For example, if a patient has a prescription for two pills to be taken twice a day for ten days, the pharmacy software will create twenty lines of orders. Each line order will request a quantity of two pills to be packaged in a packet, and each packet is assigned an hour of administration (HOA). The HOA is the time at which the medications are to be taken. For example, the HOA may be “Breakfast” or “08:00.” Each order is also grouped with other medication orders (if received) having the same HOA to allow for the creation of multi-dose HOA packets during the packaging process.

The batch file may also contain information such as the medication identifier, skip days, prescription start date and end date, medication security requirements, dispense location information, medication refrigeration temperature, the transaction type (i.e., new order, change order, dispensed, suspended, etc.) and the batch type. The batch type may be, for instance, a PRN batch (dispensed on an as needed basis), a new batch, a leave of absence (LOA) batch, an Emergency Kit or an “E-Kit” batch, etc.

An E-Kit batch is designated to create an E-Kit and/or dispense all or a portion of an E-Kit. The E-Kit can contain both pills contained within a packet, as described above, and/or medications that cannot be packaged in a packet, such as lotions, creams, powders, etc., or medications that require refrigeration. The E-Kit may be designated for a certain patient, for a certain location (e.g., the west wing of a hospital), or any other suitable use.

The pharmacy 12 also creates an electronic manifest that is a record of all medication packets and E-Kits, their contents, the dispensing schedule (HOA) for packets, the designation (e.g., patient's name, location), the refrigeration temperature needed for a medication, and any other required information for the packets and E-Kits. This manifest is sent electronically to the kiosk 18 through the data center 14 via secured messaging over a secured Wide Area Network that is controlled by the data center 14. Central control of information passing between the pharmacy 12 and the kiosk 18 permits supervision and management of data, alerts, leave of absence (LOA) notices, inventory levels, and other information. Moreover, information received from the kiosk 18, such as alarms, refill requests, and dispensing activity indicators are managed, processed, and/or distributed to the correct destinations by the data center 14. All electronic data exchanges that occur between the pharmacy 12, the data center 14, and the kiosk 18 occur over a secure network. A human call center can also respond to either dispenser or pharmacy problems in addition to the data center 14.

In response to instructions from the pharmacy 12, the kiosk 18, instructs the medication dispenser 20 to fill or dispense medications as individual packets or E-Kits. It should be appreciated that the kiosk 18 may be any suitable computing device, such as a personal computer (PC), a laptop, a tablet, a PDA, a cell phone, etc. Moreover, although the kiosk 18 is shown and described as being separate from the medication dispenser 20, it should be appreciated that the kiosk 18 may be an integral part of the medication dispenser 20.

Referring to FIG. 2, the medication dispenser 22 is defined by a packager 22 and a medication/E-Kit dispenser and organization assembly 26. The packager 22 may be any suitable oral solid medication packager that can produce bar-coded, traceable packets of oral solid medications (“pills”) (not shown). For instance, the packager 22 may be an automated high-speed packager, such as the Talyst AutoPack™, available from Talyst, Inc., of Bellevue, Wash., for filling and packaging a patient's prescriptions into the packets.

In that regard, the packager 22 may include a cabinet housing 24 that contains a plurality of canister tray subassemblies 30 that hold canisters (not shown) calibrated to contain and singulate pills of a predetermined type. Each canister tray subassembly 30 may be configured as a drawer having interior structure for removably securing a plurality of canisters therein. When closed, the drawer is locked and accessible only by authorized personnel for secure storage of the medication canisters therein and for refilling and replacement of the canisters when necessary.

The canisters are securable within a canister tray subassembly 30 in predetermined locations such that each canister is in communication with a chute subassembly 34. To dispense a pill from the canisters, a software command (from software running on the kiosk 18 or an internal computer) causes a pill to drop and travel down a corresponding chute subassembly 34 that leads to a packaging mechanism (not shown). Prior to receiving the pill, information, including the bar code, is printed on the package. The pill is then inserted into a package, sealed, and dispensed through an opening 38 in the packager.

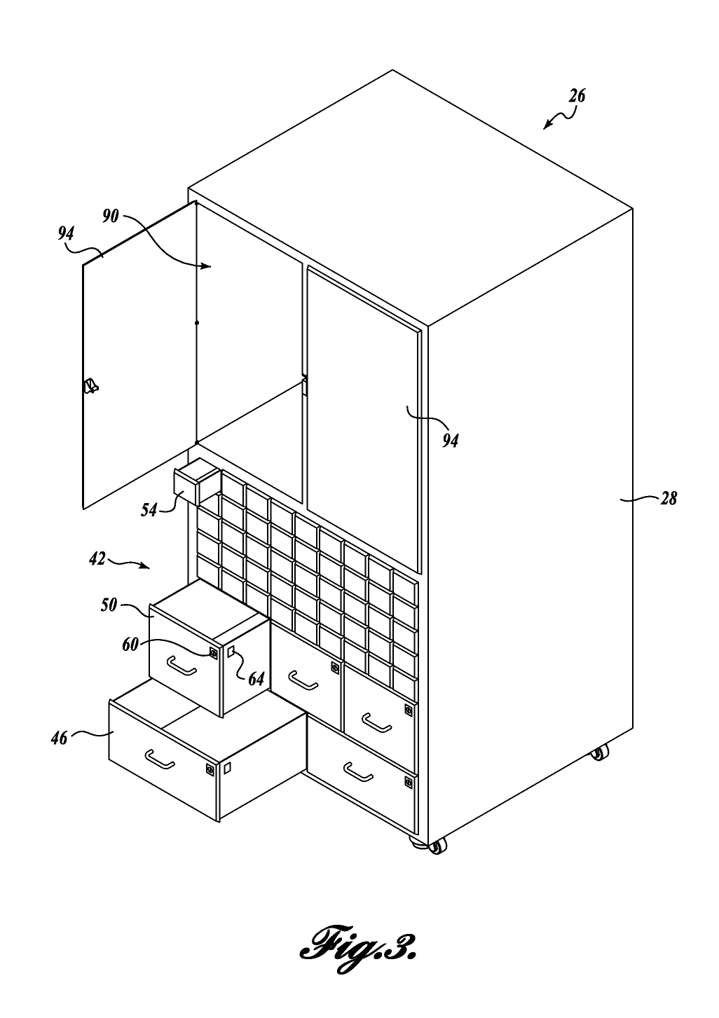

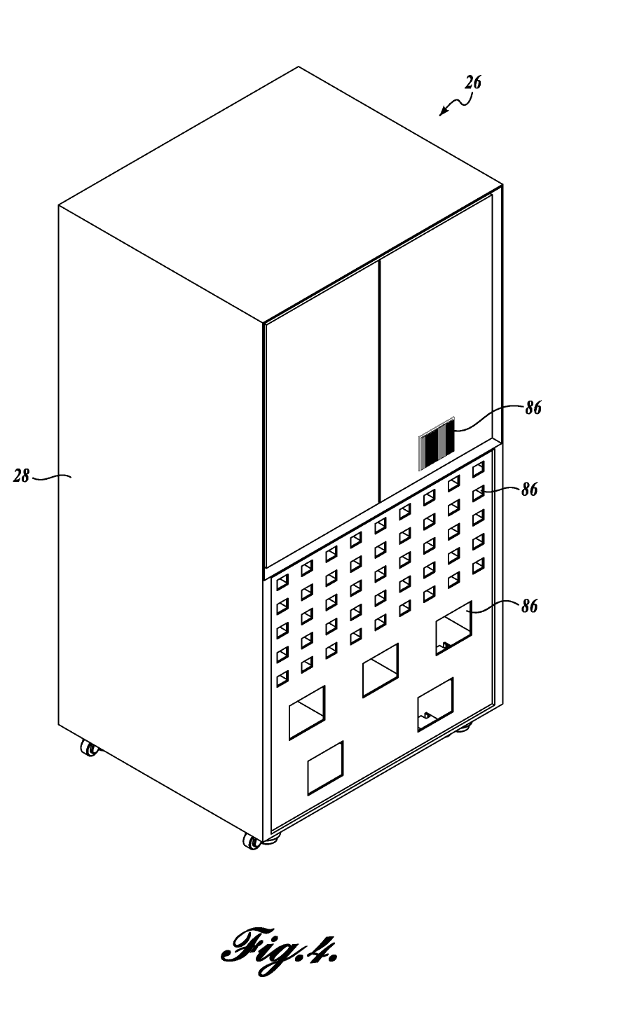

Referring to FIGS. 3 and 4, the medication/E-Kit dispenser and organization assembly 26 includes a cabinet housing 28 that contains one or more storage units, such as prepackaged medication drawer assemblies 42 configured to store prepackaged medications and/or medications other than pills that can be contained and singulated within canisters. For instance, medications such as creams, lotions, powders, vials, liquids, pre-loaded syringes, etc., that cannot be singulated and released into the chute subassembly 34 for packaging could be stored within the prepackaged medication drawer assemblies 42. In addition, medications for use in an E-Kit could be stored within the prepackaged medication drawer assemblies 42 and/or an entire E-Kit could be stored within or defined by one of the prepackaged medication drawer assemblies 42.

The prepackaged medication drawer assemblies 42 may vary in size to accommodate smaller or larger supplies of medications and/or E-Kits. For instance, the prepackaged medication drawer assemblies 42 may be defined by one or more large drawer assemblies 46, one or more medium drawer assemblies 50, and one or more small drawer assemblies 54. It should be appreciated that any suitable arrangement of the same or different drawer assemblies 42 may be used.

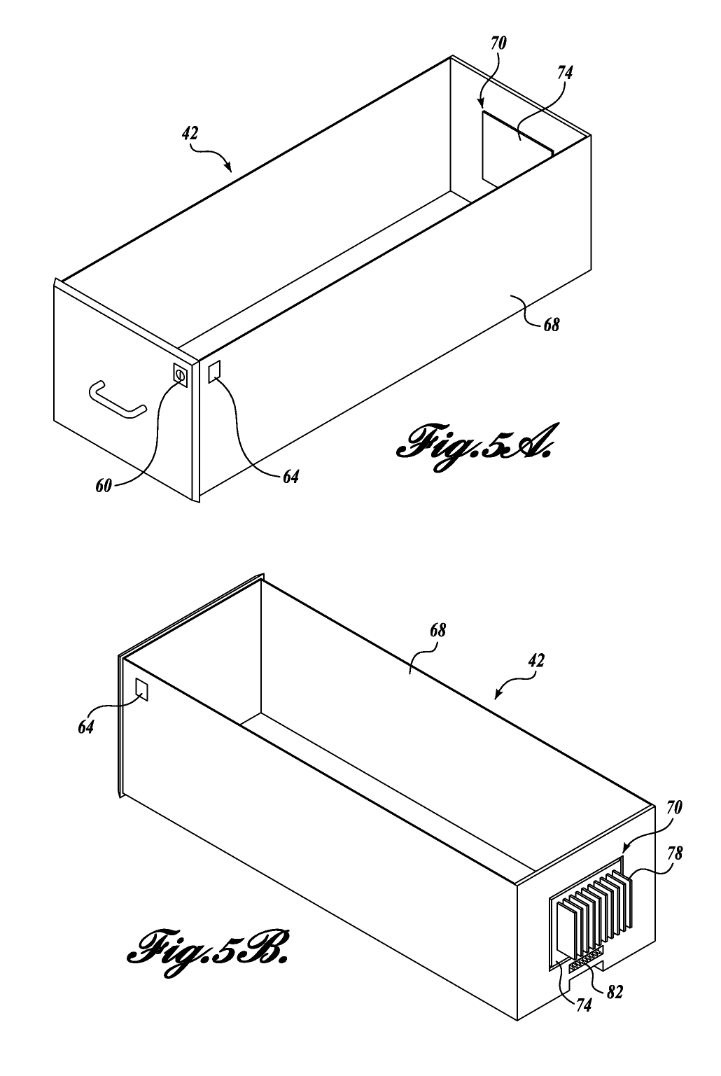

Referring to FIGS. 5A and 5B, an exemplary prepackaged medication drawer assembly 42 will be described in detail. Each drawer assembly 42 includes a drawer housing 68 suitable for holding the contents therein and for being selectively received and moved within the cabinet housing 28 of the medication/E-Kit dispenser and organization assembly 26. Each drawer assembly 42 further includes a suitable locking mechanism for selectively securing the drawer assembly 42 in a closed, locked position within the cabinet housing 28. For instance, the drawer assembly 42 may include an electromechanical lock 60 disposed within the drawer housing 68 that is configured to lock and unlock the drawer assembly 42 in response to commands from the kiosk 18 and/or an internal controller.

Each drawer assembly 42 further includes a suitable feedback mechanism, such as a switch or sensor 64, that is configured to detect the open/closed and/or the locked/unlocked status of the drawer assembly 42. The sensor 64 communicates the drawer assembly status to the kiosk 18 and/or an internal controller of the medication/E-Kit dispenser and organization assembly 26. The sensor may also communicate a location identifier of the drawer assembly 42. In this manner, the software program on the kiosk 18 may process the medication identifier data of the medications within the drawer assembly 42 and the location identifier data of the drawer assembly 42 to track inventory of the medications.

With the ability to selectively lock/unlock each drawer assembly 42 and detect the status of each drawer assembly 42, the medication/E-Kit dispenser and organization assembly 26 provides secure, restricted access to the medications container therein. As such, the operator may only access medications that are “dispensed” from the kiosk 18. In addition or in the alternative, the operator may only access medications that he/she is authorized to retrieve.

Each drawer assembly 42 may further include a cooling unit 70 for cooling the contents within the drawer assembly 42. Some of the medicines that cannot be dispensed in the oral solid pill packets, such as liquids, syringes, etc., require refrigeration at a specified temperature. The cooling unit 70 may be configured to selectively and individually cool the contents of that drawer assembly 42 at a specified temperature or temperature range, such as, for instance, between about ambient temperature and two degrees Celsius (+2° C.).

Although any suitable cooling unit 70 may be used, in the exemplary embodiment, the cooling unit 70 includes a well known Peltier device 74 that provides cooling when supplied with a predetermined voltage, such as 24 volts (24V). The Peltier device is defined by a cooling device, such as a plate secured within a rear opening (not labeled) of the drawer housing 68. The “cool” side of the plate faces the interior of the drawer housing 68. The Peltier device 74 converts electrical voltage input (initiated from the kiosk 18 and/or an internal controller of the medication/E-Kit dispenser and organization assembly 26) to cool the plate secured within the drawer housing 68. The side and bottom walls of the drawer housing 68 may be insulated to help regulate the temperature therein. Moreover, a thermocouple probe (not shown) or other temperature monitoring device may be disposed within the interior of the drawer housing 68 for monitoring the temperature therein.

A heat dissipating device, such as a heat sink 78 is secured to a rear surface of the Peltier device 74 for dissipating the heat from the interior of the drawer housing 68. The heat sink 78 protrudes from the rear surface of the drawer housing 68 and is receivable within an heat dissipating opening 86 in a rear portion of the cabinet housing 28 (see FIG. 4) when the drawer assembly 42 is received therein. In that manner, the collected, dissipated heat is not recirculated within the cabinet housing 28 to adversely affect the ability to cool other drawer assemblies 42. It should be appreciated that a single large opening may instead be defined in the cabinet housing 28 for receiving all the heat sinks of the drawer assemblies 42.

The drawer assembly 42 further includes an input/output assembly, or a power/data electrical connector assembly 82 defined on the exterior, rear surface of the drawer housing 68. The electrical connector assembly 82 is mateable with a corresponding connector assembly defined within the interior of the cabinet housing 28. The electrical connector assembly 82 is in communication with a power source to provide power to the Peltier device 70 when received within the cabinet housing 28.

The electrical connector assembly 82 is also in communication with the kiosk 18 and/or an internal controller of the medication/E-Kit dispenser and organization assembly 26 to send and receive data for controlling and monitoring the electromechanical lock 60, for controlling and monitoring the internal temperature of the drawer assembly 42, and to control any other aspects of the drawer assembly 42. For instance, in some embodiments, the drawer assembly 42 may include an electronic display (not shown) for displaying the internal temperature of the drawer assembly 42, the cabinet housing location of the drawer assembly 42, the internal contents within the drawer assembly 42, the status of the drawer assembly 42 (locked, unlocked, etc.), or to provide other visual indicators helpful to a user.

The drawer assembly 42 may be selectively securable within the cabinet housing 28. When received within the cabinet housing 28, the interior of the drawer assembly 42 and the contents therein are isolated from the other drawer assemblies 42 and interior areas of the cabinet housing 28. The drawer assembly 42 may also include suitable hardware (not shown) that allows the drawer assembly 42 to be secured within or removed from the cabinet housing 28. For instance, the drawer assembly 42 may itself define an E-Kit, and it may be removed from the cabinet housing 28 for transportation of the contents therein. In that regard, the drawer housing 68 may be configured to selectively receive a lid or other closure device for enclosing the top opening of the drawer housing 68 to help maintain a constant temperature within the drawer housing 68 during transportation.

Moreover, each drawer assembly 42 may be uniquely designed for containing specified medications. In that regard, certain drawer assemblies 42 may or may not include a cooling unit 70. With each drawer assembly 42 optionally having an individual cooling unit, each drawer assembly 42 may be uniquely designed to store a predetermine medication(s). Moreover, the drawer assemblies (whether cooled or not) have one of several different footprints (e.g., small, medium, and large) such that the drawer assemblies 42 may be received within any one of the designated openings. In that regard, the functionality of the drawer assembly 42 is unique to the drawer assembly itself rather than its location within the cabinet housing 28.

The medication/E-Kit dispenser and organization assembly 26 may further include one or more storage areas 90 that are enclosable by one or more doors 94. The storage area 90 may be suitable for storing medical equipment, E-Kits, or other desired items. The storage area 90 may or may not include one or more cooling units, similar to cooling unit 70. In the alternative, to more efficiently cool a larger storage area 90, the cooling unit may be defined as a standard refrigeration unit. The storage area 90 may include electromechanical locks and sensors for locking and monitoring the status of the doors 94. Furthermore, an electrical display may be disposed within a door 94 or other area to indicate the status of the doors, the temperature within the storage area 90, contents within the storage area 90, or other pertinent information.

As noted above, the kiosk 18 is in communication with the data center 14 and the pharmacy 12 for controlling aspects of the medication/E-Kit dispenser and organization assembly 26. The kiosk 18 can be used to control the function of the medication/E-Kit dispenser and organization assembly 26 and communicate with the data center 14 and the pharmacy 12. Any suitable software program may be installed on the kiosk 18 and a system server of the data center 14 for controlling the operation of the medication/E-Kit dispenser and organization assembly 26. Preferably, a software package similar to AutoPharm® software, available from Talyst, Inc., located in Bellevue, Wash., is used.

The software package allows for inventory tracking and dispensing control of the packager 22 and the medication/E-Kit dispenser and organization assembly 26. For example, when a certain type of medication is loaded into a canister of the packager 22, that canister is barcode labeled with a medication identifier and scanned. The scanned barcode is then assigned a location by the software package. Similarly, when a certain type of prepackaged medication is loaded within a drawer assembly 42, or storage area 90 of the medication/E-Kit dispenser and organization assembly 26, that prepackaged medication is barcode labeled with a medication identifier and scanned. The scanned barcode is then assigned a location by the software package.

A user may interface with the software package on the kiosk 18 to select a medication to be dispensed, either a pill from the canisters located in the canister tray subassemblies 22, a prepackaged medication or E-Kit from the drawer assemblies 42 or storage area 90, or an entire drawer assembly 42. To prevent unauthorized users from accessing the medications, the user must input a password before accessing the software package. Upon selecting a medication or E-Kit to be dispensed through a command input into the kiosk 18, the pill(s) will be dispensed down a chute subassembly 34 or the drawer/door of the corresponding drawer assembly 36/storage area 90 will be opened.

If a pill is dispensed and packaged, the user will remove the packaged pill(s) from the opening 34 in the packager 22. If a prepackaged medication or E-Kit is selected for dispensing, the user will remove the prepackaged medication or E-Kit from the drawer assembly 42 or storage area 90 when it is unlocked, or remove the entire drawer assembly 42 from the cabinet housing 68.

After the medications or E-Kit have been removed by the user, the user may scan a bar code on the medication or E-Kit to both verify that the correct medication or E-Kit has been picked and to upload data to the kiosk 18 indicating that the medication or E-Kit has been removed from the packager 22 or medication/E-Kit dispenser and organization assembly 26. In this manner, the inventory of the packager and the medication/E-Kit dispenser and organization assembly 26 may be tracked. The inventory levels of the medications can be automatically uploaded to the kiosk 18 and the data center 14 such that if the inventory of any medication drops below a specified level, a new order request may be automatically sent to the pharmacy 12.

In a particular embodiment, each of the packager 22 and the medication/E-Kit dispenser and organization assembly 26 may include an integrated suitable programmable logic controller (PLC) for controlling the components of the packager 22 or the medication/E-Kit dispenser and organization assembly 26.

With regard to the packager 22, the PLC can receive and process data from the kiosk 18 and sensors within the packager 22 and the PLC can control electrical components of the packager 22 in response to commands from the kiosk 18. For instance, the PLC may receive data from sensors within the packager 22 indicating the status of each canister (empty, full, other), security breaches, and other events. In response to this data, the PLC may send a signal to the kiosk 18 such that appropriate action may be taken, such as unlocking the appropriate canister tray subassemblies 22 for refilling or replacing a canister.

Moreover, upon command from the kiosk 18, the PLC may instruct a specified canister to dispense a pill from the canister, which causes a pill to drop and travel down a corresponding chute subassembly 34 that leads to the packaging mechanism (not shown). The PLC may also instruct the packaging mechanism to package the pills and print the bar code on the package.

With regard to the medication/E-Kit dispenser and organization assembly 26, the PLC receives input from the kiosk 18, from the electromechanical locks 64 and/or sensors 64 mounted to the drawer assemblies 42 (and the doors 94), from the cooling units 70 of the drawer assemblies 42 and storage area 90, from any electronic displays on the drawer assemblies 42 and storage area 90, and from other features of the medication/E-Kit dispenser and organization assembly 26 (such as a security panel, a control pad, etc.). For instance, the medication/E-Kit dispenser and organization assembly 26 may additionally include, for example, sensors for detecting events, errors, failures, security breaches, etc.

The sensor data and the signals from the kiosk 18 are processed by the PLC, which outputs appropriate control signals to control the components of the medication/E-Kit dispenser and organization assembly 26. For instance, when the user interfaces with the software package to select a medication or E-Kit to dispense, the kiosk 18 signals the PLC to unlock a drawer assembly 36, or door 94. The kiosk 18 may further signal the PLC to send a signal to the cooling unit 70 of a drawer assembly 36 or door 94 for controlling the temperature of that unit.

While the preferred embodiment of the invention has been illustrated and described, it will be appreciated that various changes can be made therein without departing from the spirit and scope of the present disclosure.

The embodiments of the invention in which an exclusive property or privilege is claimed are defined as follows:

1. A medication dispenser and organization assembly, comprising:
(a) a cabinet housing having at least first and second openings;
(b) a first storage unit for selectively storing at least one of a prepackaged oral solid medication and a non-oral solid medication and a second storage unit for selectively storing at least one of a prepackaged oral solid medication and a non-oral solid medication, the first storage unit removably received within either one of the first and second openings in the cabinet housing and the second storage unit removably received within either one of the first and second openings in the cabinet housing;
(c) a first locking mechanism for selectively locking the first storage unit within the cabinet housing and a second locking mechanism for selectively locking the second storage unit within the cabinet housing;
(d) a computing device configured to receive input selecting at least one medication to be dispensed, the computing device configured to output a first signal in response to the input; and
(e) a controller operably coupled to the first and second storage units and configured to receive the first signal from the computing device, wherein the controller is configured to output a second signal to unlock at least one of the first and second storage units.

2. The assembly of claim 1, wherein when one of the first and second storage units is unlocked, the other of the first and second storage units remains locked.

3. The assembly of claim 1, further comprising a first cooling unit disposed within the first storage unit.

4. The assembly of claim 3, wherein the first cooling unit maintains a predetermined internal temperature of the first storage unit in response to a third signal received from one of the controller and the computing device.

5. The assembly of claim 4, wherein the cooling unit comprises a cooling device at least partially disposed within the first storage unit, and a heat dissipating device in communication with the cooling device and secured to an exterior portion of the first storage unit.

6. The assembly of claim 5, wherein the first storage unit is removably receivable within one of the first and second openings in the cabinet housing such that heat dissipating device protrudes through a heat dissipating opening in the cabinet housing.

7. The assembly of claim 4, further comprising a second cooling unit disposed within the second storage unit.

8. The assembly of claim 1, further comprising a first sensor for detecting a first status of the first storage unit and a second sensor for detecting a second status of the second storage unit.

9. The assembly of claim 1, wherein each prepackaged oral solid medication and each non-oral solid medication includes a medication identifier, the first storage unit includes a first location identifier, and the second storage unit includes a second location identifier.

10. The assembly of claim 9, wherein medication identification data and location identifier data is stored in a software program of the computing device, and wherein the software program processes the medication identifier data and the location identifier data to track the location and inventory of each prepackaged oral solid medication and each non-oral solid medication.

11. A pharmaceutical packager and product organization system, comprising:
(a) medication dispenser and organization assembly, comprising:
(i) a cabinet housing having at least first and second openings;
(ii) a first storage unit for selectively storing at least one of a prepackaged oral solid medication and a non-oral solid medication and a second storage unit for selectively storing at least one of a prepackaged oral solid medication and a non-oral solid medication, the first storage unit removably received within either one of the first and second openings in the cabinet housing and the second storage unit removably received within either one of the first and second openings in the cabinet housing;
(iii) a first locking mechanism for selectively locking the first storage unit within the cabinet housing and a second locking mechanism for selectively locking the second storage unit within the cabinet housing;
(iv) a first computing device configured to receive input selecting at least one medication to be dispensed, the first computing device configured to output a first signal in response to the input; and
(v) a controller operably coupled to the first and second storage units and configured to receive the first signal from the computing device, wherein the controller is configured to output a second signal to unlock at least one of the first and second storage units; and
(b) a data center in networked communication with the first computing device, the data center configured to communicate with the first computing device for instructing the first computing device to output a first signal in response to the input.

12. The system of claim 11, further comprising a pharmacy in networked communication with at least one of the data center and the first computing device.

13. The system of claim 12, wherein the pharmacy includes a pharmacy information system having software that is capable of receiving and processing prescriptions.

14. The system of claim 13, wherein each prepackaged oral solid medication and each non-oral solid medication includes a medication identifier.

15. The system of claim 14, wherein the software creates an electronic manifest corresponding to each medication identifier that contains data regarding the prepackaged oral solid medication or the non-oral solid medication.

16. The system of claim 15, wherein the first storage unit includes a first location identifier, and the second storage unit includes a second location identifier.

17. The system of claim 16, wherein medication identification data and location identifier data is stored in a software program of the computing device, and wherein the software program processes the medication identifier data and the location identifier data to track the location and inventory of each prepackaged oral solid medication and each non-oral solid medication.

18. The system of claim 17, wherein the data center communicates with the controller for monitoring the inventory of each prepackaged oral solid medication and each non-oral solid medication.

19. The system of claim 13, wherein the data center sends unique dispensing instructions to the first computing device in response to instructions sent from the pharmacy information system.

20. The system of claim 11, wherein when one of the first and second storage units is unlocked, the other of the first and second storage units remains locked.

21. The system of claim 11, further comprising a first cooling unit disposed within the first storage unit.

22. The system of claim 21, wherein the first cooling unit maintains a predetermined internal temperature of the first storage unit in response to a third signal received from one of the controller and the computing device.

23. The system of claim 22, wherein the cooling unit comprises a cooling device at least partially disposed within the first storage unit, and a heat dissipating device in communication with the cooling device and secured to an exterior portion of the first storage unit.

24. The system of claim 23, wherein the first storage unit is removably receivable within one of the first and second openings in the cabinet housing such that heat dissipating device protrudes through a heat dissipating opening in the cabinet housing.

25. The system of claim 21, further comprising a second cooling unit disposed within the second storage unit.

26. The system of claim 11, further comprising a first sensor for detecting a first status of the first storage unit and a second sensor for detecting a second status of the second storage unit.
